(19) United States
(12) Patent Application Publication
(10) Pub. No.: US 2026/0312962 A1
(43) Pub. Date: Oct. 8, 2026

(54) COMPUTER SYSTEM AND METHOD FOR DETERMINING A CAUSE OF AN ANOMALY EVENT FOR A NETWORK DEVICE

(71) Applicant: Schneider Electric USA, Inc., Andover, MA (US)

(72) Inventor: Michael William Pyle, Hermitage, TN (US)

(73) Assignee: Schneider Electric USA, Inc., Boston, MA (US)

(21) Appl. No.: 19/170,362

(22) Filed: Apr. 4, 2025

(51) Int. Cl. H04L 9/40; G06N 20/00

(52) U.S. Cl. CPC H04L 63/1416; G06N 20/00; H04L 63/1441

(57) ABSTRACT

A computing system and process for training a machine-learning (ML) model for determining a cause of a detected anomaly event for at least one network device. Accessed are training datasets including a plurality of anomaly events for a plurality of network devices and a plurality of computer network events associated with one or more computer networks. A determination is made regarding an appearance frequency a certain anomaly event for a network device occurs within a defined time period a network event occurs. A determination is made regarding a probability a certain anomaly event for a network device is associated with a network event responsive to the determined appearance frequency, such that, when the ML model is executed, a determination is made for a likelihood a given anomaly event for a network device is caused by a given network event.

### BACKGROUND

### 1. Field

The illustrated embodiments relate generally to the field of automation and industrial control systems, such as a building management system (BMS), and a Supervisory Control and Data Acquisition (SCADA) system. The illustrated embodiments more particularly relate to systems and methods for training a machine learning model (ML) for determining a cause of a detected anomaly event for a network device in an automated and industrial control system (AIC).

### 2. Description of Related Art

An automation and industrial control (AIC) system, also commonly referred to as an Operational Technology (OT) system, such as a building management system (BMS) or a Supervisory Control and Data Acquisition (SCADA) system is, in general, a system of devices configured to control, monitor, and manage equipment and processes in or around a building, building area, or manufacturing environment. As an example, a BMS can include a heating, ventilation, and air conditioning (HVAC) system, access controls, a security system, a lighting system, a fire alerting system, another system that can manage building functions or devices, or any combination thereof. BMS devices may be installed in any environment (e.g., an indoor area or an outdoor area) and the environment may include any number of buildings, spaces, zones, rooms, or areas. A BMS may include a variety of devices/assets (e.g., HVAC devices, controllers, chillers, fans, sensors, etc.) configured to facilitate monitoring and controlling the building space.

Currently, many building management systems provide control of an entire facility, building, or other environment. The building management system may control HVAC systems, water system, lights, air quality, access controls, security, and/or any other aspect of the facility within the purview of the building management system. These systems may require skilled persons to adjust, control, and otherwise operate the building management system, due to the complexity. In large facilities or buildings, this management can be labor intensive. Moreover, in buildings where dynamic management of the building management system is required (e.g., buildings with multiple independent HVAC requirements), advanced control strategies may be required.

A particular functionality of an AIC system is detecting anomalous events in the OT devices and associated processes they are involved in to identify possible areas of misoperation or failure in the AIC/OT system. It is noted that OT refers to the hardware and software systems that detect or cause changes through direct monitoring and control of physical devices, processes, and events in the OT system(s) of an enterprise. This is in contrast to Information Technology (IT), which deals with the use of systems for data-centric computing. For instance, OT is commonly used in industrial settings, such as manufacturing, energy, transportation, and utilities, where it is critical for managing and controlling physical processes and machinery. Examples of OT systems include: SCADA systems, BMS systems, DCS (Distributed Control Systems), and Industrial Automation systems that incorporate devices such as PLCs (Programmable Logic Controllers).

With regard to the embodiments described herein, it is to be understood and appreciated that while OT processes generally work reliably, unexpected mis-operation or functional failure of devices involved in the processes of an OT system often occur, often resulting in significant disruptions that may pose a risk to both business and people. It is noted, when this occurs, the fault may be in the device, caused by a bad component or a bug, but cyber-attack against OT devices can also be the cause, with the resulting failure often masquerading as a device failure. For instance, the well-known Triton attack is representative of a cyber-attack that was initially mistaken as a device failure/quality issue.

A current problem is network anomalies and process anomalies/failures are reviewed by two difference groups through two different processes, as network anomalies are captured by an intrusion detection system (IDS) and viewed by people in a SOC or monitoring a SEIM tool, while process anomalies/alerts/failures are reported up to facility or process engineers in a process control room by associated process software such as a BMS software application or SCADA software. Thus, a significant current problem is neither process (e.g., IDS and SCADA) knows what the other process is seeing due to the current isolation of each process relative to one another, due to their incompatibility with one another.

### SUMMARY

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings.

To achieve these and other advantages and in accordance with the purpose of the illustrated embodiments, in one aspect, described is a computer system and method that provides a computer-implemented method for a network monitoring device/system for determining a root cause of a detected anomaly event for at least one network device using one or more computer algorithmic techniques. At least one network device is operatively coupled to a computer network that is monitored by: 1) a Supervisory Control and Data Acquisition (SCADA) system for detecting one or more operational anomaly events associated with one or networked OT devices, sensors linked to OT devices, or OT processes, and 2) an Intrusion Detection System (IDS) for detecting one or more network events associated with a computer network that is coupled to, or otherwise associated with, the one or more network devices.

Captured, in a computer processor of the network monitoring device, from the AIC system, preferably is data related to a detected process anomaly event for the at least one networked OT device or process. Also captured in the network monitoring device, from the IDS, is data related to a detected network event occurring in the computer network. The network monitoring device is configured and operational to correlate (and/or align), using the one or more computer algorithmic techniques, the captured data from the AIC system and IDS to determine (and assign likelihood) if the detected process anomaly event for the at least one network device was, potentially, caused by a network anomaly event, preferably by a determined confidence value.

In accordance with another aspect, described is a computing system and process for training a machine-learning (ML) model for determining a cause of a detected anomaly event for at least one network device. Preferably, a training dataset is accessed including a plurality of anomaly events for a plurality of network devices, and also accessed is a training dataset including a plurality of computer network events associated with one or more computer networks the plurality of network devices can be coupled to. A determination is made regarding an appearance frequency a certain anomaly event for a network device occurs within a defined time period a network event occurs based upon analysis of data present in the accessed training datasets. Next, a determination is made regarding a probability a certain anomaly event for a network device is associated with a network event responsive to the determined appearance frequency, such that, when the machine-learning model is executed, the machine-learning model is configured to determine a likelihood a given anomaly event for a network device is caused by a given network event responsive to the probability determination.

Thus, the illustrated embodiments for determining a root cause of a detected anomaly event for at least one networked OT device or process in an automated and industrial control system (AIC) provides a technical improvement to a computer-controlled AIC system by automating the process for determining a root cause of a detected anomaly event for at least one network device.

### BRIEF DESCRIPTION OF THE DRAWINGS

So that those skilled in the art to which the subject disclosure appertains will readily understand how to make and use the devices and methods of the subject disclosure without undue experimentation, preferred illustrated embodiments thereof will be described in detail herein below with reference to certain figures, wherein:

FIG. 1 illustrates an example communication network utilized with one or more of the illustrated embodiments;

FIG. 2 illustrates an example network device/node utilized with one or more of the illustrated embodiments;

FIG. 3 illustrates a diagram depicting an Artificial Intelligence (AI) device utilized with one or more of the illustrated embodiments;

FIG. 4 illustrates a diagram depicting an AI server utilized with one or more of the illustrated embodiments;

FIG. 5 illustrates a simplified system level diagram of an AIC in accordance with the illustrated embodiments;

FIG. 6 illustrates a process for determining a root cause of a detected anomaly event for at least one network device in accordance with the illustrated embodiments; and

FIG. 7 illustrates a process for training a ML model for determining a root cause of a detected anomaly event in accordance with the illustrated embodiments.

### DESCRIPTION OF CERTAIN EMBODIMENTS

The illustrated embodiments are now described more fully with reference to the accompanying drawings wherein like reference numerals identify similar structural/functional features. The illustrated embodiments are not limited in any way to what is illustrated as the illustrated embodiments described below are merely exemplary, which can be embodied in various forms, as appreciated by one skilled in the art. Therefore, it is to be understood that any structural and functional details disclosed herein are not to be interpreted as limiting, but merely as a basis for the claims and as a representation for teaching one skilled in the art to variously employ the discussed embodiments. Furthermore, the terms and phrases used herein are not intended to be limiting but rather to provide an understandable description of the illustrated embodiments.

Unless defined otherwise, all technical and scientific terms used herein have the same meaning as commonly understood by one of ordinary skill in the art to which this illustrated embodiment belongs. Although any methods and materials similar or equivalent to those described herein can also be used in the practice or testing of the illustrated embodiments, exemplary methods and materials are now described.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the illustrated embodiments discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the illustrated embodiments based on the above-described embodiments. Accordingly, the illustrated embodiments are not to be limited by what has been particularly shown and described, except as indicated by the appended claims.

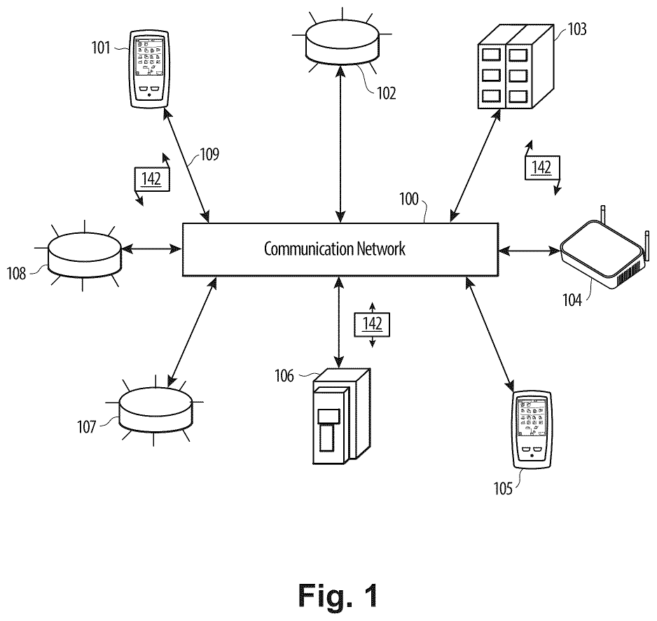

Turning now descriptively to the drawings, in which similar reference characters denote similar elements throughout the several views, FIG. 1 depicts an exemplary communications network 100 in which below illustrated embodiments may be implemented. It is to be understood a communication network 100 is a geographically distributed collection of nodes interconnected by communication links and segments for transporting data between end nodes, such as personal computers, work stations, smart phone devices, tablets, televisions, sensors, Programmable Logic Controllers (PLCs), BMS, electrical distribution devices, motor control, safety systems, and or other devices such as automobiles, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical light paths, synchronous optical networks (SONET), synchronous digital hierarchy (SDH) links, or Powerline Communications, and others. Specifically, regarding buildings/plants/grids, protocols such as Building Automation Control Network (BACNet), Modbus, OPC Unified Architecture (OPC-UA), and the IEC61850 standard may be used, for instance.

FIG. 1 is a schematic block diagram of an example communication network 100 illustratively comprising nodes/devices 101-108 (e.g., sensors 102, computing monitoring device 103, smart phone devices 105, web servers/computer systems 106 (e.g., a SCADA system), computer systems 103, switches 108, databases, and the like) interconnected by various methods of communication. For instance, the links 109 may be wired links or may comprise a wireless communication medium, where certain nodes are in communication with other nodes, e.g., based on distance, signal strength, current operational status, location, etc. Moreover, each of the devices can communicate data packets (or frames) 142 with other devices using predefined network communication protocols as will be appreciated by those skilled in the art, such as various wired protocols and wireless protocols etc., where appropriate. In this context, a protocol consists of a set of rules defining how the nodes interact with each other. Those skilled in the art will understand that any number of nodes, devices, links, etc. may be used in the computer network, and that the view shown herein is for simplicity. Also, while the embodiments are shown herein with reference to a general network cloud, the description herein is not so limited and may be applied to networks that are hardwired.

As will be appreciated by one skilled in the art, aspects of the illustrated embodiments may be embodied as a system, method or computer program product. Accordingly, aspects of the illustrated embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the illustrated embodiments may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the illustrated embodiments may be written in any combination of one or more programming languages, including an object oriented programming language such as Python, Golang, Ruby, ASP. NET, Java,, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the illustrated embodiments are described below with reference to flowchart illustrations and/or block diagrams of methods, apparatus (systems) and computer program products according to the illustrated embodiments. It will be understood that each block of the flowchart illustrations and/or block diagrams, and combinations of blocks in the flowchart illustrations and/or block diagrams, can be implemented by computer program instructions. These computer program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which executed on the computer or other programmable apparatus provide processes for implementing the functions/acts specified in the flowchart and/or block diagram block or blocks.

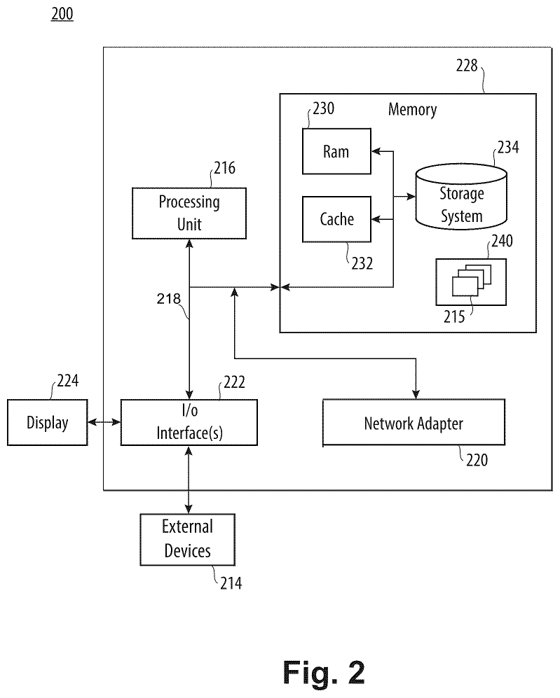

FIG. 2 is a schematic block diagram of an example network computing device 200 (e.g., computing monitoring device 103, SCADA computer system 106, IDS 120, etc.) that may be used (or components thereof) with one or more embodiments described herein, e.g., as one of the nodes shown in the network 100. As explained above, in different embodiments these various devices are configured to communicate with each other in any suitable way, such as, for example, via communication network 100. It is to be appreciated and understood that in certain illustrated embodiments, the computer monitoring device 103 as described herein, may be a separate computer component/system (e.g., network 100 coupled), or may be integrated as unitary component/system with a AIC (e.g., BMS or SCADA) 106 computer system and/or an IDS 120.

Device 200 is intended to represent any type of computer system capable of carrying out the teachings of various illustrated embodiments. Device 200 is only one example of a suitable system and is not intended to suggest any limitation as to the scope of use or functionality of the illustrated embodiments described herein. Regardless, computing device 200 is capable of being implemented and/or performing any of the functionality set forth herein, including an AIC computer system 106, an IDS 120, and a computer monitoring system 103 configured and operative, preferably using one or more artificial intelligence techniques, for determining a cause of a detected anomaly event for at least one network device using one or more computer algorithmic techniques.

Computing device 200 is operational with numerous other special purpose computing system environments or configurations. Examples of well-known computing systems, environments, and/or configurations that may be suitable for use with computing device 200 include, but are not limited to, cloud computing systems (including, but not limited to: Infrastructure as a Service (IaaS); Software as a Service (Saas); Platform as a Service (PaaS); and Private cloud), personal computer systems, server computer systems, thin clients, thick clients, hand-held or laptop devices, multiprocessor systems, microprocessor-based systems, programmable consumer electronics, network PCs, minicomputer systems, and distributed data processing environments that include any of the above systems or devices, and the like. Computing device 200 may be described in the general context of computer system-executable instructions, such as program modules, being executed by a computer system. Generally, program modules may include routines, programs, objects, components, logic, data structures, and so on that perform particular tasks or implement particular abstract data types. Computing device 200 may be practiced in distributed data processing environments where tasks are performed by remote processing devices that are linked through a communications network. In a distributed data processing environment, program modules may be located in both local and remote computer system storage media including memory storage devices. In accordance with the illustrated embodiments, computing device 200 (e.g., computer monitoring system 103) is configured and operative for determining a cause of a detected anomaly event for at least one networked OT device or process using one or more computer algorithmic techniques, preferably using one or more AI techniques.

The components of device 200 may include, but are not limited to, one or more processors or processing units 216, a system memory 228, and a bus 218 that couples various system components including system memory 228 to processor 216. Bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. Computing device 200 typically includes a variety of computer system readable media. Such media may be any available media that is accessible by device 200, and it includes both volatile and non-volatile media, removable and non-removable media.

System memory 228 can include computer system readable media in the form of volatile memory, such as random-access memory (RAM) 230 and/or cache memory 232. Computing device 200 may further include other removable/non-removable, volatile/non-volatile computer system storage media. By way of example only, storage system 234 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 218 by one or more data media interfaces. As will be further depicted and described below, memory 228 may include at least one program product having a set (e.g., at least one) of program modules that are configured to carry out the functions of embodiments of illustrated embodiments.

Program/utility 240, having a set (at least one) of program modules 215, such as underwriting module, may be stored in memory 228 by way of example, and not limitation, as well as an operating system, one or more application programs, other program modules, and program data. Each of the operating system, one or more application programs, other program modules, and program data or some combination thereof, may include an implementation of a networking environment. Program modules 215 generally carry out the functions and/or methodologies of the illustrated embodiments as described herein, including, but not limited to, preferably using one or more AI techniques, or statistical analysis techniques, to determine a cause of a detected anomaly event for at least one network device using one or more computer algorithmic techniques.

It is to be appreciated and understood device 200 may also communicate with or connect with one or more external devices 214 such as sensors, a keyboard, a pointing device, a display 224, etc. ; one or more devices that enable a user to interact with computing device 200; and/or any devices (e.g., network card, modem, etc.) that enable computing device 200 to communicate with one or more other computing devices or receive analog input from the physical world. Such communication can occur via Input/Output (I/O) interfaces 222. Still yet, device 200 can communicate with one or more networks such as a local area network (LAN), a general wide area network (WAN), and/or a public network (e.g., the Internet) via network adapter 220. As depicted, network adapter 220 communicates with the other components of computing device 200 via bus 218. It should be understood that although not shown, other hardware and/or software components could be used in conjunction with device 200. Examples, include, but are not limited to: big data technologies encompassing large and diverse datasets that are significant in volume, which are commonly used in machine learning, predictive modeling, and other advanced analytics to solve business problems and make informed decisions; non-relational databases (NoSQLs); Blob storage; relational databases (SQL); as well as microcode, device drivers, redundant processing units, external disk drive arrays, RAID systems, tape drives, and data archival storage systems, etc.

FIGS. 1 and 2 are intended to provide a brief, general description of an illustrative and/or suitable exemplary environment in which the below described illustrated embodiments may be implemented. FIGS. 1 and 2 are exemplary of a suitable environment and are not intended to suggest any limitation as to the structure, scope of use, or functionality of an illustrated embodiment. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

It is to be understood the embodiments described herein are preferably provided with self-learning/Artificial Intelligence (AI) to determine a cause of a detected anomaly event for at least one network device using one or more computer algorithmic techniques. Thus, preferably integrated into a computer monitoring system (e.g., 103) coupled to a plurality of external databases/data sources is an AI system that implements machine learning and artificial intelligence algorithms to determine a cause of a detected anomaly event for at least one network device using one or more computer algorithmic techniques, preferably on an automated basis. For instance, the AI system may include two subsystems: a first sub-system that learns from historical data; and a second subsystem to identify and recommend one or more parameters or approaches based on the learning. It should be appreciated that although the AI system may be described as two distinct subsystems, the AI system can also be implemented as a single system incorporating the functions and features described with respect to both subsystems.

In accordance with the illustrated embodiments described herein, artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

Also, in accordance with the illustrated embodiments, an artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value. The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function. The purpose of the learning of the artificial neural network may be to determine the model parameters that minimize a loss function. The loss function may be used as an index to determine optimal model parameters in the learning process of the artificial neural network. Machine learning may be classified into supervised learning, unsupervised learning, and reinforcement learning according to a learning method. The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

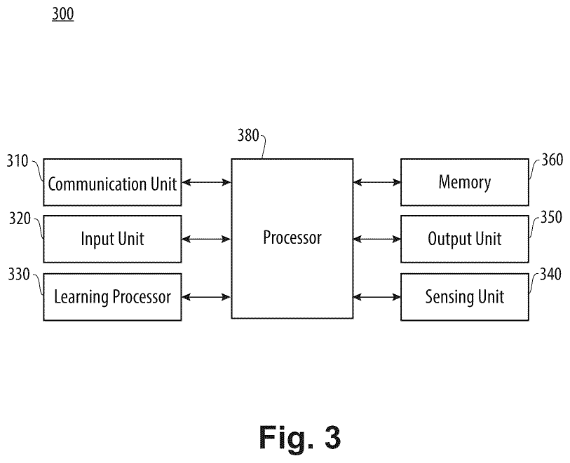

Machine learning, which is implemented as a deep neural network (DNN) including a plurality of hidden layers among artificial neural networks, is also referred to as deep learning, and the deep learning is part of machine learning. FIG. 3 illustrates an AI device 300 according to an illustrated embodiment. In accordance with the illustrated embodiments, the AI device 300 is preferably integrated into in the computer monitoring system 103.

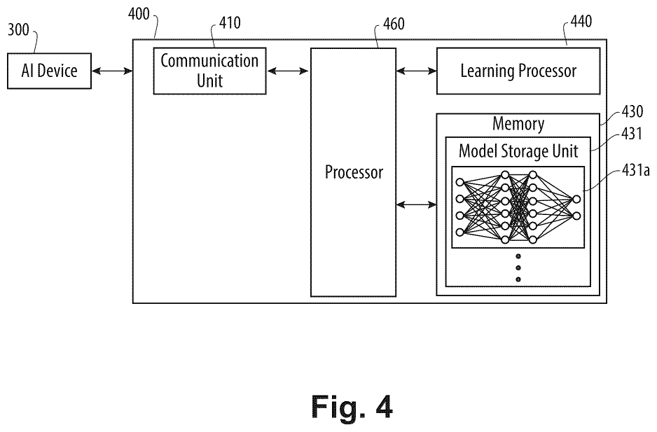

Referring now FIG. 3, in conjunction with FIGS. 1 and 2, the AI device 300 is operatively coupled to, or integrated with computing device 200, in accordance with the illustrated embodiments described herein. AI device 300 preferably includes a communication unit 310, an input unit 320, a learning processor 330, a sensing unit 340, an output unit 350, a memory 360, and a processor 380. The communication unit 310 may transmit and receive data to and from external devices such as other AI devices 300a to 300e and an AI server 400 (FIG. 4) by using wire/wireless communication technology. For example, the communication unit 310 may transmit and receive sensor information, a user input, a learning model, and a control signal to and from external devices.

The communication technology used by the communication unit 310 preferably includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input unit 320 may acquire various kinds of input data, including, but not limited to network data relating a network device received from an AIC system 106 and data from an IDS 120 regarding cyber network events occurring on a computer network 100 associated with network devices, to be used when an output is acquired by using learning model. The input unit 320 may acquire raw input data. In this case, the processor 380 or the learning processor 330 may extract an input feature by preprocessing the input data. The learning processor 330 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

The learning processor 330 may perform AI processing together with the learning processor 330 of the AI server 400, and the learning processor 330 may include a memory integrated or implemented in the AI device 300. Alternatively, the learning processor 330 may be implemented by using the memory 360, an external memory directly connected to the AI device 300, or a memory held in an external device. The sensing unit 340 may acquire at least one of internal information about the AI device 300, ambient environment information about the AI device 300, and user information by using various sensors.

The output unit 350 preferably includes a display unit for outputting/displaying relevant information to a user in accordance with the illustrated embodiments described herein. The memory 360 preferably stores data that supports various functions of the AI device 300. For example, the memory 360 may store input data acquired by the input unit 320, learning data, a learning model, a learning history, and the like.

The processor 380 preferably determines at least one executable operation of the AI device 300 based on information determined or generated by using a data analysis algorithm or a machine learning algorithm. The processor 380 may control the components of the AI device 300 to execute the determined operation. To this end, the processor 380 may request, search, receive, or utilize data of the learning processor 330 or the memory 360. The processor 380 may control the components of the AI device 300 to execute the predicted operation or the operation determined to be desirable among the at least one executable operation. When the connection of an external device is required to perform a determined operation, the processor 380 may generate a control signal for controlling the external device and may transmit the generated control signal to the external device. The processor 380 may acquire intention information for the user input and may determine the user's requirements based on the acquired intention information. The processor 380 may acquire the intention information corresponding to the user input by using at least one of a speech to text (STT) engine for converting speech input into a text stream or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 330, may be learned by the learning processor 340 of the AI server 400, or may be learned by their distributed processing. The processor 380 may collect history information including the operation contents of the AI device 300 or the user's feedback on the operation and may store the collected history information in the memory 360 or the learning processor 330 or transmit the collected history information to the external device such as the AI server 400. The collected history information may be used to update the learning model.

The processor 380 may control at least part of the components of AI device 300 so as to drive an application program stored in memory 360. Furthermore, the processor 380 may operate two or more of the components included in the AI device 300 in combination so as to drive the application program.

FIG. 4 illustrates an AI server 400 according to the illustrated embodiments. It is to be appreciated that the AI server 400 may refer to a device that learns an artificial neural network by using a machine learning algorithm or uses a learned artificial neural network. The AI server 400 may include a plurality of servers to perform distributed processing or may be defined as a 5G network. The AI server 400 may be included as a partial configuration of the AI device 300 and may perform at least part of the AI processing together. The AI server 400 may include a communication unit 410, a memory 430, a learning processor 440, a processor 460, and the like. The communication unit 410 can transmit and receive data to and from an external device such as the AI device 300. The memory 430 may include a model storage unit 431. The model storage unit 431 may store a learning or learned model (or an artificial neural network 431a) through the learning processor 440.

The learning processor 440 may learn the artificial neural network 431a by using the learning data. The learning model may be used in a state of being mounted on the AI server 400 of the artificial neural network or may be used in a state of being mounted on an external device such as the AI device 300. The learning model may be implemented in hardware, software, or a combination of hardware and software. If all or part of the learning models are implemented in software, one or more instructions that constitute the learning model may be stored in memory 430. The processor 460 may infer the result value for new input data by using the learning model and may generate a response or a control command based on the inferred result value.

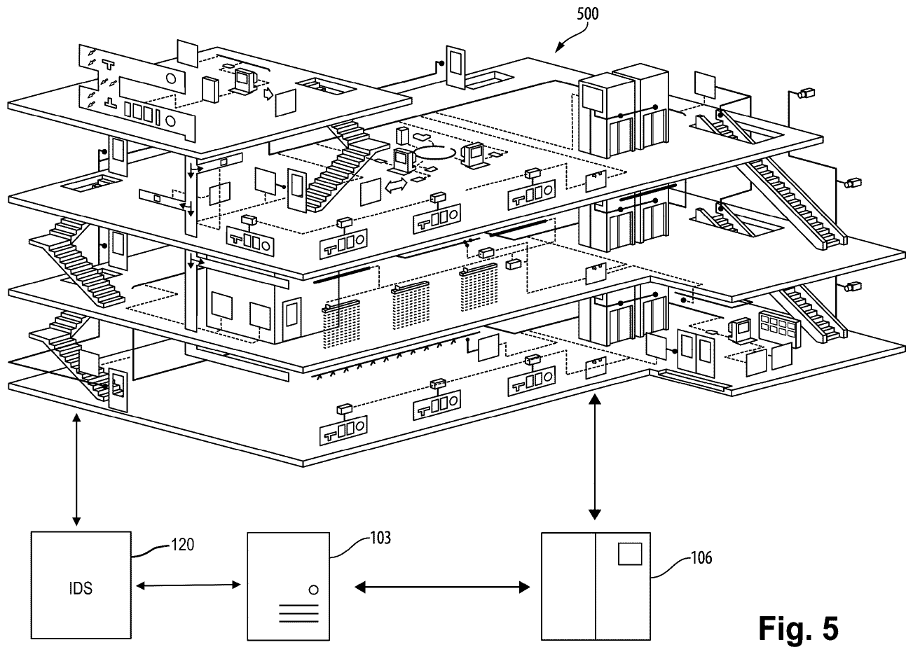

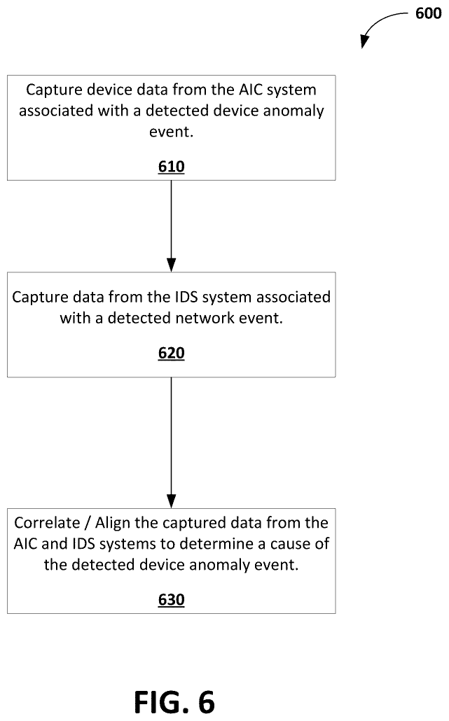

With the exemplary communication network 100 (FIG. 1), computing device 200 (FIG. 2), AI device 300 (FIG. 3) and AI server 400 (FIG. 4) being generally shown and discussed above, description of certain illustrated embodiments will now be provided with below reference to FIGS. 5 and 6 (and with continuing reference to FIGS. 1-4). It is to be understood and appreciated that FIGS. 1-4 are intended to provide a brief, general description of an illustrative and/or suitable exemplary environment in which the below described illustrated embodiments may be implemented. FIGS. 1-4 are exemplary of a suitable environment and are not intended to suggest any limitation as to the structure, scope of use, or functionality of an illustrated embodiment. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

In accordance with the illustrated embodiments, and with reference to FIG. 5, it is to be understood and appreciated that an AIC system, such as a building management system (BMS) or a Supervisory Control and Data Acquisition (SCADA) system, is a computer-based system 106 that monitors and controls a building's 500 devices, such as (but not limited to): mechanical and electrical equipment including (including, but not limited to; HVAC (heating, ventilation, air conditioning), lighting, power systems, fire systems, and security systems). The AIC 106 may be configured to collect data samples from building equipment (e.g., sensors, controllable devices, building subsystems, etc.) and generate raw timeseries data from the data samples. The AIC 106 processes the raw timeseries data using a variety of data platform services to generate optimized timeseries data (e.g., data rollup timeseries, virtual point timeseries, fault detection timeseries, etc.). The optimized timeseries data can be provided to various applications and/or stored in local or hosted storage. In some embodiments, the AIC 106 includes three different layers that separate (1) data collection, (2) data storage, retrieval, and analysis, and (3) data visualization. This allows the BMS 106 to support a variety of applications that use the optimized timeseries data and allows new applications to reuse the infrastructure provided by the data platform services.

It is to be further understood and appreciated that while the illustrated embodiments are described relative for use with a SCADA system 106, it is not to be understood to be limited thereto as the computer monitoring system 103 in accordance with the illustrated embodiments may have application to other automation and industrial control system (AIC) systems, such as a BMS system. Thus, in this instance, the AIC 106 is a SCADA system whereupon the computer monitoring system 103 is operatively coupled to a SCADA system 106 for detecting anomaly events relating to one or more network devices (e.g., 502-506) coupled to a computer network (e.g., 100) associated with an enterprise 500. For instance, the coupled network devices (e.g., 502-506) may include (but are not to be limited to), one or more of: a circuit breaker component, a network router, a network repeater, a network gateway, a network bridge, a network modem, a network firewall, a network hub, a network access point, a network switch, a programmable logic controller (PLC), an energy metering device, Remote Terminal Unit (RTU), a Protective Relay, a Motor Drive, Safety Device and other devices that are typically used in IT and Operational Technology (OT) systems.

As is known, a SCADA system 106 is computer-based system utilizing software and hardware to monitor, control, and analyze industrial processes and devices. SCADA systems can be used remotely or on-site to collect data from industrial equipment, which supervisors can then use to optimize and control operations. SCADA systems are often referred to as automation technology and are used in many industries, including energy and power, data centers, energy grids, power systems, manufacturing, food and beverages, oil and gas, water and wastewater, and transportation. For ease of description purposes, the computer monitoring system 103 in accordance with the illustrated embodiments is described for use with a SCADA system 106, but as mentioned above, it has application with other AIC systems, such as a BMS, and thus is not to be understood to be limited to application with a SCADA system 106.

Also coupled to the computer network (e.g., 100) that is hosting the building's 500 devices, is an Intrusion Detection System (IDS) 120, which is a critical component in computer security designed to monitor network or system activities for malicious actions or policy violations. For instance, an IDS 120 is a security technology that helps detect unauthorized access, misuse, device configuration changes, or compromise of computer systems and networks. In accordance with the illustrated embodiments, an IDS 120 may consist of (but is not to be understood to be limited to): a Security Information and Event Management (SIEM) system, Network Node Intrusion Detection System (NNIDS), Host Intrusion Detection System (HIDS), Anomaly-based Intrusion Detection System (AIDS), Network-based Intrusion Prevention System (NIPS), and Host-based Intrusion Prevention System (HIPS).

An IDS 120 typically functions by analyzing computer network traffic and activities within a network (e.g., 100, 500) or on individual devices (e.g., 502-506) to identify suspicious patterns that may indicate a security breach. An example of an IDS 120, is a network-based IDS (NIDS) configured to monitor network traffic for suspicious activity. It is typically deployed at strategic points within the network to analyze data packets. Another type of IDS system 120 is a host-based IDS (HIDS) configured for monitoring the activities on individual devices or hosts with an enterprise 500. For instance, it examines system logs, file integrity, and other host-specific activities. In some embodiments, the IDS 120 is configured and functional to compare observed activities against a database of known attack signatures. It is effective for identifying known threats. It is also configured and operative to perform anomaly-based detection by establishing a baseline of normal behavior and flags deviations from this baseline as potential threats, which method detects novel attacks. Further exemplary functions of an IDS 120 include: a) Monitoring—continuously observing network traffic or system activities; b) Alerting—generating alerts when suspicious activities are detected; c) Logging—recording details of

detected incidents for further analysis; and d) Reporting—providing reports on detected threats and system vulnerabilities. Exemplary benefits of an IDS 120 include: a) Early Detection—identifies potential security breaches early, allowing for prompt response; b) Incident Response—assisting in investigating and responding to security incidents; and c) Compliance—enables organizations to satisfy regulatory requirements for security monitoring and reporting. Thus, it is to be understood and appreciated that an IDS 120 is a critical tool for enhancing the security posture of an organization (e.g., 500) by providing continuous monitoring and alerting capabilities. For instance, it complements other security measures, such as firewalls and antivirus software, to create a more robust defense against cyber threats.

In accordance with the illustrated embodiments, and with reference to process 600 of FIG. 6 (with continuing reference to FIGS. 1-5) described is a computer system and method/process that provides a computer-implemented method/process for one or more network devices (e.g., 502-506) for determining a root cause of a detected anomaly event for the one or more network devices (e.g., 502-506), using one or more computer algorithmic techniques, which preferably uses one or more AI techniques (FIGS. 3 and 4) in accordance with certain illustrated embodiments. It is to be understood the one or more network devices (e.g., 502-506) are operatively coupled to a computer network (e.g., 100) for an enterprise 500 that is monitored by: 1) a Supervisory Control and Data Acquisition (SCADA) system 106 for detecting one or more anomaly events associated with one or more network devices (e.g., 502-506), and 2) an Intrusion Detection System (IDS) 120 for detecting one or more network events associated with a computer network (e.g., 100) that is coupled to, or otherwise associated with, the one or more network devices (e.g., 502-506).

Starting at step 610, data from one or more network devices (e.g., 502-506) is captured in the computer monitoring device 103 from the AIC/SCADA/BMS system 106 preferably relating to a detected process anomaly event(s) associated with the one or more network devices (e.g., 502-506). For instance, a device anomaly event may consist of (and is not to be understood to be limited to) one or more of: a network device (e.g., 502-506) operating outside an expected operation range, an over and/or under voltage condition for a network device, and a power factor correction anomaly for a network device, unexpected failure or crashing of a device, unexpected changes in device configuration, mis-reporting of monitored values, opening or closing outputs when unplanned or outside of normal operation, etc.

Proceeding to step 620, data from an IDS 120 is captured in the computer monitoring device 103 relating to one or more detected network events occurring in the computer network 100 associate with an enterprise 500. For instance, and in accordance with the illustrated embodiments, the detected network event (step 620) may consist of (and is not to be understood to be limited to) one or more of a cyber-attack, configuration change data associated with a network device, and one or more misconfigured network settings, communications or attempted communications from a device or computer to another falling outside of the normal established communication patterns.

Next, at step 630, the computer monitoring device 103, in accordance with the illustrated embodiments, is configured and operative to correlate and/or align, using one or more computer algorithmic techniques, the captured data from the SCADA system 106 with the captured data from the IDS 120 to determine and/or assign a likelihood if a detected OT device or process anomaly event for one or more of the network devices or processes (e.g., 502-506) was caused by a network anomaly event occurring on the computer network(s) (e.g., 100) associated with an enterprise 500 the one or more network devices (e.g., 502-506) is also associated with. In accordance with the illustrated embodiments, the one or more computer algorithmic techniques may consist of one or more Artificial Intelligence (AI) techniques (e.g., FIGS. 3-4) and/or a statistical algorithmic technique.

The correlating/aligning step (630) preferably includes determining if a detected process anomaly event for the at least one OT network device or process (e.g., 502-506) was caused by an OT misoperation, device failure or bug, (as detected by the SCADA system 106) or by a network event (as detected by the IDS 120). In accordance with the illustrated embodiments, the correlating step (630) preferably includes determining a confidence level the detected process anomaly event for the at least one network device (e.g., 502-506) was caused by a network event (as detected by the IDS 120) by determining the degree of correlation between the detected process anomaly event and detected network events. For instance, the correlating step (630) may include determining a confidence level the detected process anomaly event for the at least one network device (e.g., 502-506) was caused by each of a 1) network anomaly event (as detected by the IDS 120), or a 2) process anomaly event (as detected by the SCADA 106). The one or more AI techniques may consist of utilization of a Machine Learning (ML) model trained to determine if the detected process anomaly event for the at least one network device (e.g., 502-506) was caused by a network anomaly event (as detected by the IDS 120).

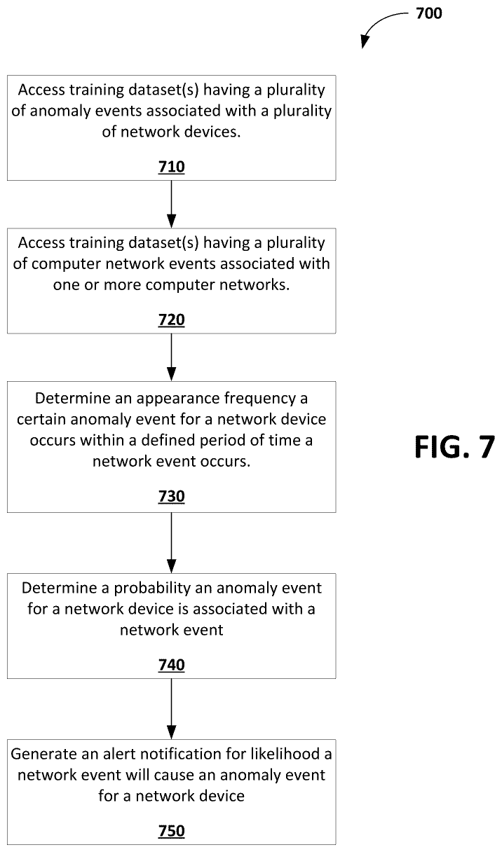

In accordance with certain illustrated embodiments, process 600 further includes training, by a computer processor, a machine learning (ML) model to determine a probability of likelihood a detected process anomaly event (as detected by the SCADA 106) for at least one network device (e.g., 502-506) was caused by a network anomaly event (as detected by the IDS 120) (as will be further described below with reference to process 700 of FIG. 7). For instance, the trained ML model may include a plurality of input parameters each corresponding to a different process anomaly event for a network device (e.g., 502-506) and different network events, and an output having output labels and weights associated with process anomaly events and network events resulting from the input parameters. The ML model is trained to determine a probability of likelihood the detected process anomaly event for the at least one network device (e.g., 502-506) was caused by a network anomaly event may include: processing, by a computer processor, historical data related to process anomaly events for network devices (e.g., 502-506) and historical data related to network events, and training the ML model using the processed historical data. For instance, processing the historical data may include converting unstructured data to structured data suitable for training the ML model, and processing the historical data may further include performing Natural Language Processing (NLP) techniques to transform at least a portion of the process anomaly events and network events to a data format compatible for training the trained ML model (it is noted, currently, the IDS 120 and SCADA 106 systems each utilize data that are incompatible for use by the other system). In certain illustrated embodiments, further included is measuring, by the computer monitoring device/system 103, the accuracy of the trained ML model for determining a probability of likelihood the detected process anomaly event for the at least one network device was caused by a network anomaly event by using, for instance, a F1 score for improving the performance of a binary classification model. Additionally, the trained ML model may be updated in real-time with data related to process anomaly events for network devices (e.g., 502-506) and data related to network events to determine the detected process anomaly event for the at least one network device (e.g., 502-506) was caused by a network anomaly event. Additionally, in certain embodiments, training the ML model further includes utilization of historical data from a prescribed time period consisting of data related to process anomaly events for network devices (e.g., 502-506) and data related to network events, wherein the trained ML model is configured to provide real-time indication of a probability of likelihood the detected process anomaly event for the at least one network device was caused by a network anomaly event. Thus, it is to be understood and appreciated that the aforesaid ML model is preferably trained to determine a probability of likelihood the detected process anomaly event for the at least one network device (e.g., 502-506) was caused by a network anomaly event, which may include processing simulated historical data related to process anomaly events for network devices and simulated historical data related to different network events.

Specifically, with reference now to FIG. 7 (with continuing reference to FIGS. 1-6), described now is a computing system and method for training a machine-learning (ML) model for determining a cause of a detected process anomaly event for at least one network device (e.g., 502-506). In certain embodiments, training of ML model includes supervised training. Starting at step 710, a computer device, such as computer monitoring device/system 103, accesses one or more training datasets including a plurality of process anomaly events for a plurality of network devices (e.g., 502-506). It is noted this training dataset including a plurality of process anomaly events may be accessed from one or more internal data sources and/or external data sources. Additionally, the anomaly events may consist of both process anomaly events and operational anomaly events. Further, the training dataset for the plurality of network events preferably includes historical data related to network events and may further include simulated data related to network events. As mentioned above, a network device (e.g., 502-506) may consist of (and is not to be limited to): a circuit breaker component, a network router, a network repeater, a network gateway, a network bridge, a network modem, a network firewall, a network hub, a network access point, a network switch, a programmable logic controller (PLC), an energy metering device, a software application such as but not limited to a Supervisory, Control And Data Acquisition (SCADA) software or Building Management software, a Remote Terminal Unit (RTU), a Protective Relay, a Motor Drive, Safety Device and other devices that are typically used in IT and Operational Technology (OT) systems. And as also mentioned above, an anomaly event may consists of one or more of (and is also not to be limited to): a network device operating outside an expected operation range, an over and/or under voltage condition for a network device, and a power factor correction anomaly for a network device, unexpected failure or crashing of a device, unexpected changes in device configuration, mis-reporting of monitored values, opening or closing outputs when unplanned or outside of normal operation.

Next, at step 720, the computer monitoring device 103 accesses one or more training datasets including a plurality of computer network events associated with one or more computer networks (e.g., 100) the plurality of network devices (e.g., 502-506) can be and/or are coupled to. As mentioned above, a detected network event may consist of one or more of (and is not to be limited to): a cyber-attack, configuration change data associated with a network device, and one or more misconfigured network settings. It is noted this training dataset including a plurality of computer network events may be accessed from one or more internal data sources and/or external data sources. It is further noted the training dataset for the plurality of network events may include simulated data related to network events, and wherein the computer device 103 is further caused to convert unstructured data to structured data suitable for training the machine-learning model. In certain embodiments, the computer monitoring device 103 is further caused to access a plurality of input parameters each corresponding to a different anomaly event for a network device (e.g., 502-506), and different network events, and an output having output labels and weights associated with process anomaly events and network events resulting from the input parameters. Further, the computer device 103 is further configured and operative to perform Natural Language Processing (NLP) techniques to transform at least a portion of each training dataset to a data format compatible for training the ML model.

Proceeding now to step 730, once the computer device/system 103 has accessed the aforesaid training datasets for anomaly events (step 710) and network events (step 720), it is configured and operative to determine an appearance frequency a certain anomaly event for a network device (e.g., 502-506) occurs within a defined time period a network event occurs, which may include use of one or more AI/ML techniques for making such a determination.

Next, at step 740, the computer device 103 determines a probability a certain anomaly event for a network device (e.g., 502-506) is associated with a network event that is responsive to the determined appearance frequency (step 730), such that when the trained ML model is executed, the ML model is configured to determine likelihood a given anomaly event for a network device (e.g., 502-506) is caused by a given network event, responsive to the probability determination. Preferably, the trained ML model is configured to provide real-time indication of a probability of likelihood the detected anomaly event for the at least one network device was caused by a network anomaly event (e.g., 502-506).

In accordance with certain embodiments, when the ML model is executed, it is configured and operative to: 1) detect the occurrence of a network event, responsive to data received from an Intrusion Detection System (IDS 120) on a given network (e.g., 100) a given network device is coupled to (e.g., 502-506); and 2) determine a probability the given network event is going to cause a given anomaly event to occur for the given network device (e.g., 502-506) contingent upon a determined probability the anomaly event for the given network device (e.g., 502-506) is associated with the given network event. In certain embodiments, the ML model further determines a confidence level the given anomaly event for the given network device (e.g., 502-506) is caused by the given network event.

In certain embodiments, the computer device 103 is further configured and operative to determine the accuracy of the trained ML model for determining a probability of likelihood a given detected anomaly event for a given network device was caused by a given network anomaly event by using a F1 score for improving the performance of a binary classification model. Additionally, the computer device 103 is further configured and operative to update (preferably in real-time) the trained ML model with data related to anomaly events for network devices (e.g., 502-506) and data related to network events to determine the anomaly event for the at least one network device (e.g., 502-506) was caused by a network anomaly event.

And in accordance with certain embodiments, at step 750, the computer device 103 is further operative and configured to, responsive to determining a given anomaly event for a network device (e.g., 502-506) is caused by a given network event responsive to the probability determination (step 740), an alert is caused to be generated at a particular computing system, to which the network device (e.g., 502-506) is coupled to, wherein the alert preferably notifies the particular computing system, or a user of the particular computing system, the likelihood that the given anomaly event for the network device (e.g., 502-506) was caused by the given network event. It is noted that in certain embodiments, the computer device 103 is further operative and configured to cause an alert to be generated at a particular computing system, to which the network device (e.g., 502-506) is coupled to, the alert notifying the particular computing system or a user of the particular computing system that the given anomaly event for the given network device (e.g., 502-506) is likely to occur.

It is to be appreciated and understood that the prior problems discussed above for detecting an actual root cause of an anomaly event for a network device (e.g., 502-506) have been overcome and solved by the above illustrated embodiments by providing an OT intrusion detection solution (e.g., the computer monitoring device/system 103), preferably operating at a layer above the intrusion detection and process/OT systems, by aggregating and analyzing the alerts and errors (anomalies) reported by both systems (e.g., SCADA 106 and IDS 120) for possible correlation or alignment to determine and report on the likelihood, or confidence, of possible cause and effect. For example, when a breaker trips unexpectedly, the device event log collected by the SCADA 106 may indicate there was a change to the breaker's configuration three (3) days ago. Even though the IDS 120 did not report a network anomaly involving the breaker, the computer monitoring device 103 of illustrated embodiments is operational and configured to report a high likelihood the unexpected trip of the breaker was caused by an unintentional cyber event allowing an error in configuration. For instance, perhaps the person with access to the control software had privileges allowing them to change configuration devices, when they weren't properly trained. As another example, the IDS 120 reports unusual communication to a sensor measuring the temperature of a mixture created in an automated process. A few hours later the PLC controlling the process unexpectedly shuts down the process due to too high of a temperature in the mixture. Again, the computer monitoring device 103 of the illustrated embodiments is configured and operational to determine/report a high likelihood the unexpected trip of the breaker was caused by a cyber event.

Thus, it is to be appreciated and understood the illustrated embodiments for determining a root cause of a detected anomaly event for at least one network device in an automated and industrial control system (AIC) provides a technical improvement to a computer-controlled AIC system by automating the process for determining a root cause of a detected anomaly event for at least one network device (e.g., 502-506).

With certain illustrated embodiments described above, it is to be appreciated that various non-limiting embodiments described herein may be used separately, combined or selectively combined for specific applications. Further, some of the various features of the above non-limiting embodiments may be used without the corresponding use of other described features. The foregoing description should therefore be considered as merely illustrative of the principles, teachings and exemplary embodiments of the illustrated embodiments, and not in limitation thereof.

It is to be understood that the above-described arrangements are only illustrative of the application of the principles of the illustrated embodiments. Numerous modifications and alternative arrangements may be devised by those skilled in the art without departing from the scope of the illustrated embodiments, and the appended claims are intended to cover such modifications and arrangements.

What is claimed is:

1. A computing system for training a machine-learning (ML) model for determining a cause of a detected anomaly event for at least one network device, comprising:
one or more processors; and
one or more computer-readable media having stored thereon computer-executable instructions that are structured such that, when executed by the one or more processors, cause the computing system to perform at least:
access a training dataset including a plurality of anomaly events for a plurality of network devices;
access a training dataset including a plurality of computer network events associated with one or more computer networks the plurality of network devices can be coupled to;
determine an appearance frequency a certain anomaly event for a network device occurs within a defined time period a network event occurs based upon analysis of data present in the accessed training datasets; and
determine a probability a certain anomaly event for a network device is associated with a network event responsive to the determined appearance frequency, wherein:
when the machine-learning model is executed, the machine-learning model is configured to determine likelihood a given anomaly event for a network device is caused by a given network event responsive to the probability determination.

2. The computer system for training a machine-learning model as recited in claim 1, wherein a network device anomaly event is either a process anomaly event or an operational anomaly event.

3. The computer system for training a machine-learning model as recited in claim 1, wherein the computer system is further caused to, responsive to determining the probability a given anomaly event for a network device is caused by a given network event, cause an alert to be generated at a particular computing system to which the network device is coupled to, wherein the alert notifies the particular computing system or a user of the particular computing system the likelihood that the given anomaly event for the network device was caused by the given network event.

4. The computer system for training a machine-learning model as recited in claim 1, wherein when the machine-learning model is executed, the machine-learning model is configured to:
detect the occurrence of a network event, responsive to data received from an Intrusion Detection System (IDS) on a given network, a given network device is coupled to; and
determine a probability the given network event is going to cause a given anomaly event to occur for the given network device contingent upon a determined probability the anomaly event for the given network device is associated with the given network event.

5. The computer system for training a machine-learning model as recited in claim 4, wherein the machine-learning model further causes an alert to be generated at a particular computing system, to which the network device is coupled to, the alert notifying the particular computing system or a user of the particular computing system that the given anomaly event for the given network device is likely to occur.

6. The computer system for training a machine-learning model as recited in claim 1, wherein training of the machine-learning model includes supervised training.

7. The computer system for training a machine-learning model as recited in claim 1, wherein the machine-learning model further determines a confidence level the given anomaly event for the given network device is caused by the given network event.

8. The computer system for training a machine-learning model as recited in claim 1, wherein the computer system is further caused to access a plurality of input parameters each corresponding to a different anomaly event for a network device, and different network events, and an output having output labels and weights associated with process anomaly events and network events resulting from the input parameters.

9. The computer system for training a machine-learning model as recited in claim 1, wherein the training dataset for the plurality of anomaly events includes historical data related to anomaly events for network devices.

10. The computer system for training a machine-learning model as recited in claim 1, wherein the training dataset for the plurality of network events includes historical data related to network events.

11. The computer system for training a machine-learning model as recited in claim 1, wherein the training dataset for the plurality of anomaly events includes simulated data related to anomaly events for network devices.

12. The computer system for training a machine-learning model as recited in claim 1, wherein the training dataset for the plurality of network events includes simulated data related to network events.

13. The computer system for training a machine-learning model as recited in claim 1, wherein the computer system is further caused to convert unstructured data to structured data suitable for training the machine-learning model.

14. The computer system for training a machine-learning model as recited in claim 1, wherein the computer system is further caused to perform Natural Language Processing (NLP) techniques to transform at least a portion of each training dataset to a data format compatible for training the machine-learning model.

15. The computer system for training a machine-learning model as recited in claim 1, wherein the computer system is further caused to determine the accuracy of the trained ML model for determining a probability of likelihood a given detected anomaly event for a given network device was caused by a given network anomaly event by using a F1 score for improving the performance of a binary classification model.

16. The computer system for training a machine-learning model as recited in claim 1, wherein the trained ML model is updated in real-time with data related to anomaly events for network devices and data related to network events to determine whether the anomaly event for the at least one network device was caused by a network anomaly event.

17. The computer system for training a machine-learning model as recited in claim 1, wherein the trained ML model is configured to provide real-time indication of a probability of likelihood the detected anomaly event for the at least one network device was caused by a network anomaly event.

18. The computer system for training a machine-learning model as recited in claim 1, wherein a network device consists of one or more of: a circuit breaker component, a network router, a network repeater, a network gateway, a network bridge, a network modem, a network firewall, a network hub, a network access point, a network switch, a programmable logic controller (PLC), an energy metering device, a software application such as but not limited to a Supervisory, Control And Data Acquisition (SCADA) software or Building Management software, a Remote Terminal Unit (RTU), a Protective Relay, a Motor Drive, Safety Device and other devices that are typically used in IT and Operational Technology (OT) systems.

19. The computer system for training a machine-learning model as recited in claim 1, wherein an anomaly event consists of one or more of: a network device operating outside an expected operation range, an over and/or under voltage condition for a network device, and a power factor correction anomaly for a network device, unexpected failure or crashing of a device, unexpected changes in device configuration, mis-reporting of monitored values, opening or closing outputs when unplanned or outside of normal operation, etc.

20. The computer system for training a machine-learning model as recited in claim 1, wherein the detected network event consists of one or more of a cyber-attack, configuration change data associated with a network device, and one or more misconfigured network settings.

21. A computer-implemented process for training a machine-learning (ML) model for determining a cause of a detected anomaly event for at least one network device, comprising the steps:
accessing, by a computer processor, a training dataset including a plurality of anomaly events for a plurality of network devices;
accessing, by the computer processor, a training dataset including a plurality of computer network events associated with one or more computer networks the plurality of network devices can be coupled to;
determining, by the computer processor, an appearance frequency a certain anomaly event for a network device occurs within a defined time period a network event occurs based upon analysis of data present in the accessed training datasets; and
determining, by the computer processor, a probability a certain anomaly event for a network device is associated with a network event responsive to the determined appearance frequency, wherein when the machine-learning model is executed, the machine-learning model is configured to determine likelihood a given anomaly event for a network device is caused by a given network event responsive to the probability determination.
